(19) United States
(12) Patent Application Publication
(10) Pub. No.: US 2017/0350322 A1
(43) Pub. Date: Dec. 7, 2017

(54) HEATED STARTER AIR VALVE

(71) Applicant: Hamilton Sundstrand Corporation, Charlotte, NC (US)

(72) Inventor: Myles R. Kelly, Willimantic, CT (US)

(21) Appl. No.: 15/171,557

(22) Filed: Jun. 2, 2016

(51) Int. Cl. F02C 7/24; F02C 7/26; F02C 3/04

(52) U.S. Cl. CPC F02C 7/24; F02C 3/04; F02C 7/26

(57) ABSTRACT

A heated valve is provided and includes a valve body having an inlet, an outlet downstream from the inlet and a valve section fluidly interposed between the inlet and the outlet, a valve element operably disposed within the valve section to assume and move between at least a first position at which fluid communication between the inlet and the outlet is prevented by the valve element and a second position at which the fluid communication is permitted and a heating system. The heating system is in operable communication with at least one of the valve body and the valve element and is configured to melt ice that could prevent movement of the valve element between the first and second positions.

### BACKGROUND OF THE DISCLOSURE

The subject matter disclosed herein relates to starter air valves and, more particularly, to heated starter air valves.

In aircrafts and other similar machines, starter air valves can be provided as parts of engines and may be oriented vertically. Such starter air valves can thus collect water due to condensation and, if the aircraft in which the starter air valve is installed sits overnight in a cold place, the collected water can freeze within the valve body. This frozen water can prevent the starter air valve from opening during start-up operations of the aircraft engines and may cause flight delays or cancellations.

One design that has been proposed for addressing the problem of frozen water in starter air valves is that drainage features are incorporated into the valve body. The drainage features can be formed as drain holes and allow collected water to flow through them out of the valve body. As such, the drainage features are capable of preventing the collected water from pooling and then freezing.

### BRIEF DESCRIPTION OF THE DISCLOSURE

According to one aspect of the disclosure, a heated valve is provided and includes a valve body having an inlet, an outlet downstream from the inlet and a valve section fluidly interposed between the inlet and the outlet, a valve element operably disposed within the valve section to assume and move between at least a first position at which fluid communication between the inlet and the outlet is prevented by the valve element and a second position at which the fluid communication is permitted and a heating system. The heating system is in operable communication with at least one of the valve body and the valve element and is configured to melt ice that could prevent movement of the valve element between the first and second positions.

In accordance with additional or alternative embodiments, a valve actuator is coupled to the valve element and configured to drive movements thereof.

In accordance with additional or alternative embodiments, the valve body is disposable with the inlet above the outlet.

In accordance with additional or alternative embodiments, the valve body is substantially cylindrical and the valve element includes a butterfly valve.

In accordance with additional or alternative embodiments, the heating system includes a heating element operably disposed within at least the valve body and a power source coupled to and configured to activate the heating element to generate heat.

In accordance with additional or alternative embodiments, the valve element includes a valve plate and a drive shaft configured to drive movements of the valve plate and the heating system includes a valve plate heating element disposed to heat the valve plate and a coupling configured to electrically connect the valve plate heating element and the power source during movements of the valve element.

In accordance with additional or alternative embodiments, the valve body includes first and second layers and the heating element includes a resistance wire interposed between the first and second layers.

In accordance with additional or alternative embodiments, the valve body further includes a seal ring disposable on an interior surface of an innermost one of the first and second layers.

According to another aspect of the disclosure, a valve body is provided and includes an inner layer formed to define an inlet, an outlet downstream from the inlet and a valve section fluidly interposed between the inlet and the outlet, an outer layer disposed to surround the inner layer and a heating element operably interposed between the inner and outer layers and configured to generate heat proximate to a valve element operably disposed within the valve section to assume and move between valve closing and valve opening positions.

In accordance with additional or alternative embodiments, at least the valve section is annular and the valve element is a butterfly valve.

In accordance with additional or alternative embodiments, the heating element includes a resistance wire interposed between the first and second layers.

In accordance with additional or alternative embodiments, a seal ring is disposable on an interior surface of an innermost one of the first and second layers.

According to yet another aspect of the disclosure, an engine is provided and includes a gas turbine engine section, a starter configured to start the gas turbine engine section and a valve system configured to control airflow into the starter during operations to start the gas turbine engine section. The valve system includes a valve body, a valve element operably disposed within the valve body to assume and move between valve body closing and valve body opening positions, a heating element operably disposed within at least the valve body and a power source coupled to and configured to activate the heating element to generate heat.

In accordance with additional or alternative embodiments, a valve actuator is configured to drive movements of the valve element.

In accordance with additional or alternative embodiments, the valve body is disposable such that fluid pools on the valve element in the valve body closing position.

In accordance with additional or alternative embodiments, a valve element heater is disposed to heat the valve element and a coupling is configured to electrically connect the valve element heater and the power source during movements of the valve element.

In accordance with additional or alternative embodiments, the valve body includes first and second layers and the heating element includes a resistance wire interposed between the first and second layers.

In accordance with additional or alternative embodiments, the valve body further includes a seal ring disposable on an interior surface of an innermost one of the first and second layers.

In accordance with additional or alternative embodiments, the first and second layers and the resistance wire include metallic materials.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic diagram of an aircraft engine in accordance with embodiments;

FIG. 2 is a perspective view of a starter air valve in accordance with embodiments;

FIG. 3 is a side view of the starter air valve in an operational mode;

FIG. 4 is an axial view of a valve body taken along line 4-4 of FIG. 2;

FIG. 5 is a circumferential view of the valve body taken along line 5-5 of FIG. 4;

FIG. 6 is a cutaway side view of the valve body and a heating element in accordance with embodiments; and

FIG. 7 is a side view of a valve plate heating element and a coupling in accordance with embodiments.

The detailed description explains embodiments of the disclosure, together with advantages and features, by way of example with reference to the drawings.

### DETAILED DESCRIPTION OF THE DISCLOSURE

A problem with the drainage features of starter air valves of aircraft engines is that the drainage features often permit air leakage when the valves are closed. This reduces efficiencies of the engines and their associated system. Thus, as will be described below, a starter air valve is provided in which electric heat is used to melt ice that would otherwise prevent the starter air valve from opening prior to start-up of the engine. Such use of electric heat allows for the starter air valve to not have need for drainage features and so will decrease leakage when the starter air valve is in the closed position thus increasing system efficiency. The use of the electric heat could be applicable and used in any pneumatic valve environment where ice build-up could occur inside the valve and prevent the valve from opening.

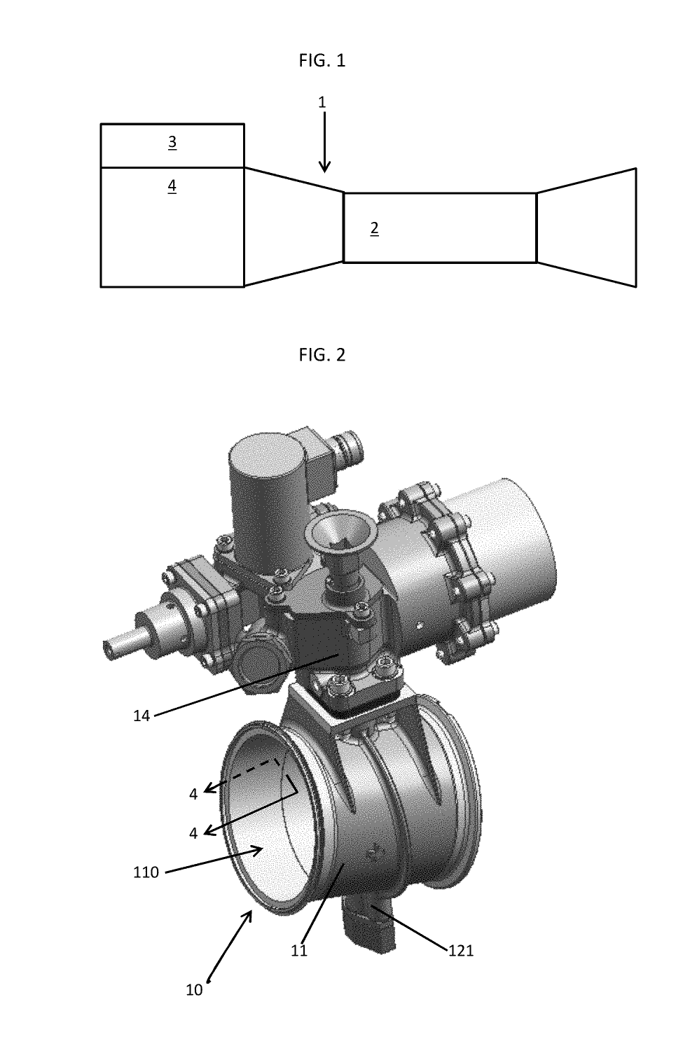

With reference to FIG. 1, an engine 1 is provided for use with an aircraft or another similar machine. The engine includes a gas turbine engine section 2 and a starter 3 which is configured to start the gas turbine engine section 2. The gas turbine engine section 2 has a compressor that compresses inlet air, a combustor in which the compressed inlet air is mixed with fuel and combusted and a turbine in which high temperature and high pressure fluids produced by the combustion are expanded. The turbine is coupled to a rotor which is turned by the expansion of the high temperature and high pressure fluids and the rotor, in turn, turns the compressor.

During start-up operations of the engine 1 and before the turbine is up to speed, the starter 3 is coupled to the gas turbine engine section 2 and thereby turns the rotor and the compressor. Such operation of the starter requires airflow to be modulated by a starter air valve 4 disposed upstream from the starter 3. In many cases, the starter air valve 4 is oriented substantially vertically within the engine 1 and thus tends to collect water therein due to condensation. This water can freeze if the surrounding air is cold enough (e.g., if the associated aircraft is parked overnight in cold weather) with the resulting ice potentially preventing the starter air valve 4 from opening during engine 1 start-up operations.

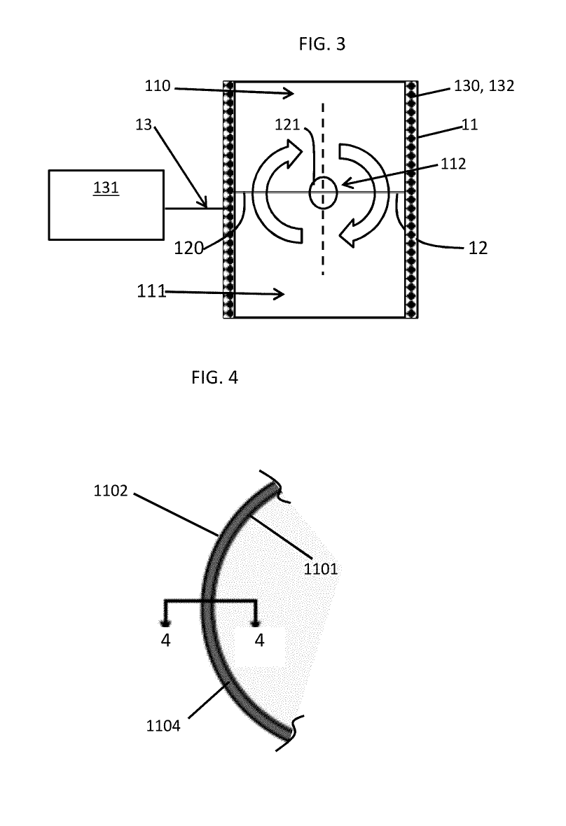

Thus, with reference to FIGS. 2 and 3, a heated valve 10 is provided and may be configured as a heated starter air valve for use in the starter 3 of the engine 1 of FIG. 1 or in any pneumatic valve environment. In any case, the heated valve 10 includes a valve body 11, a valve element 12 and a heating system 13. The valve body 11 has an inlet section 110, an outlet section 111 downstream from the inlet section 110 and a valve section 112 which is fluidly interposed between the inlet section 110 and the outlet section 111. The valve element 12 is operably disposable within the valve section 112 to assume and move between at least a first (or closed) position at which fluid communication between the inlet section 110 and the outlet section 111 is prevented by the valve element 12 and a second (or open) position at which the fluid communication between the inlet section 110 and the outlet section 111 is permitted.

The heating system 13 is disposable in operable communication with at least one of the valve body 11 and the valve element 12 and is configured to melt ice that could prevent movement of the valve element 12 between the first and second positions. The heating system 13 may include at least a heating element 130 that is operably disposable within at least the valve body 11 and a power source 131. The power source 131 is coupled to and configured to activate the heating element 130 to generate heat.

The power source 131 can be a battery or some other source of electricity that supplies the heating element 131, such as a resistance wire 132 formed of metallic materials (e.g., copper), with current. This current causes the heating element 130 to heat and this heat is conducted into the valve body 11 or radiated outwardly to generally raise the temperature of the valve 11 in and around at least the valve section 112. As a result, any ice formed within the valve body 11 is melted so that the valve element 12 can freely move within the valve body 11.

In accordance with embodiments, the valve body 11 may be substantially cylindrical with the inlet section 110, the outlet section 111 and the valve section being generally annular at least in their respective interior spaces. Here, the valve element 12 may be provided as a butterfly valve including a valve plate 120 and a drive shaft 121. The drive shaft 121 is coupled with the valve plate 120 and extends through the valve body 11 to a valve actuator 14, which is coupled to an exterior of the valve body 11. The valve actuator 14 is configured to drive rotations of the drive shaft 121 about its longitudinal axis such that the drive shaft 121 drives rotational movements of the valve 120. The rotational movements of the valve plate 120 may be directed such that the valve plate 120 rotates from the first (or closed) position to the second (or open) position and from the second position to the first position.

In certain cases, with reference to FIG. 3, the valve body 11 may be oriented substantially vertically with the inlet section 110 above the outlet section 111 and the valve section 112. Thus, when the valve plate 120 occupies the first (or closed) position, water can collect within the valve section 112 and then pool on an upper surface of the valve plate 120. If this water freezes, the resulting ice can prevent the rotational movements of the valve plate 120 but the activation of the heating element 130 generates heat and thereby prevents such freezing and the blocking of the valve plate 120.

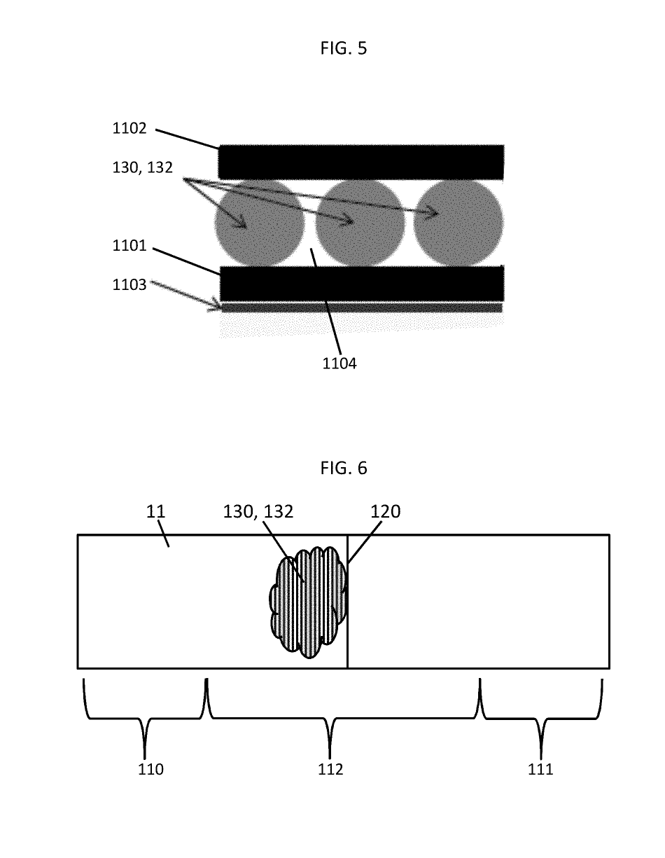

With reference to FIGS. 4 and 5, the valve body 11 may include a first layer 1101, a second layer 1102 and a seal ring 1103. Of the first and second layers, one would be an inner layer and the other would be an outer layer. For purposes of clarity and brevity, it will be assumed that the first layer 1101 is the inner layer and that an interior surface of the first layer 1101 forms the inlet section 110, the outlet section 111 and the valve section 112 and is annular. Thus, the second layer 1102 is disposed to surround the inner layer 1101 at a distance such that an annular space 1104 is defined between an exterior surface of the first layer 1101 and an interior surface of the second layer 1102. The heating element 130 (i.e., the resistance wire 132) may be interposed between the first layer 1101 and the second layers 1102 and within the annular space 1004. In accordance with embodiments, where the heating element 130 is the resistance wire 132, a diameter or thickness of the heating element 130 may be substantially similar to that of the annular space 1104. As such, the heating element 130 and the first layer 1101 form an extended contact surface along a substantial entirety of a length of the heating element 130. The seal ring 1103 may be disposed on the interior surface of the first layer 1101 such that edges of the valve plate 120 register with the seal ring 1103 with the valve plate 120 occupying the first (or closed) position.

As shown in FIG. 5, where the heating element 130 is the resistance wire 132, a highly thermally conductive material, such as foamed metallic material, can be charged into the annular space 1104 to take up empty space that is not otherwise occupied by the resistance wire 132.

The first and second layers 1101 and 1102 may be formed of metallic materials or, more generally, of highly thermally conductive materials. The first and second layers 1101 and 1102 may be, but are not required to be, electrically conductive.

With reference to FIG. 6 and, in accordance with further embodiments, the heating element 130 may be disposed in the annular space 1104 at the valve section 112 upstream from the axial location of the valve plate 120 in the first (or closed) position. Where possible, the heating element 130 may also be disposed at the inlet section 110, at the valve section downstream from the axial location of the valve plate 120 and at the outlet section 112.

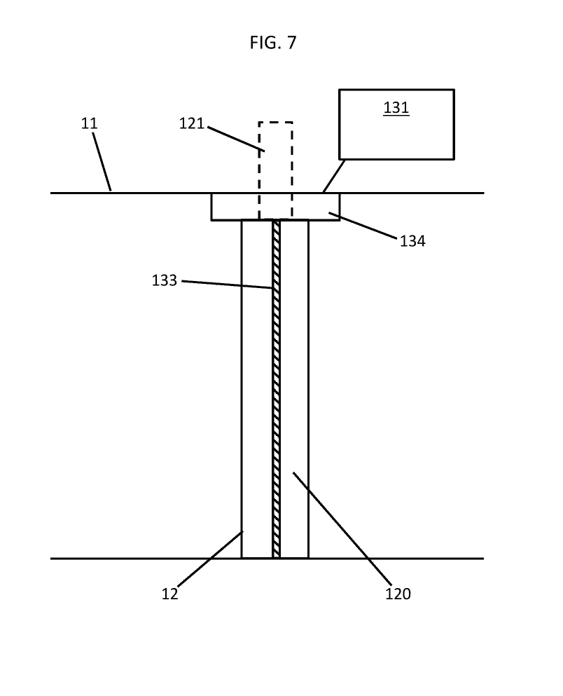

With reference to FIG. 7 and, in accordance with further embodiments in which the valve element 12 is a butterfly valve, the heating system 13 may include a valve plate heating element 133 and a coupling 134. The valve plate heating element 133 is disposed to heat the valve plate 120 similar to the way the heating element 130 heats the valve body 11. The coupling 134 is configured to electrically connect the valve plate heating element 133 and the power source 131 during movements of the valve plate 120 and may be provided as a brush ring or another similar feature.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A heated valve, comprising:
a valve body having an inlet, an outlet downstream from the inlet and a valve section fluidly interposed between the inlet and the outlet;
a valve element operably disposed within the valve section to assume and move between at least a first position at which fluid communication between the inlet and the outlet is prevented by the valve element and a second position at which the fluid communication is permitted; and
a heating system in operable communication with at least one of the valve body and the valve element and configured to melt ice that could prevent movement of the valve element between the first and second positions.

2. The heated valve according to claim 1, further comprising a valve actuator coupled to the valve element and configured to drive movements thereof.

3. The heated valve according to claim 1, wherein the valve body is disposable with the inlet above the outlet.

4. The heated valve according to claim 1, wherein the valve body is substantially cylindrical and the valve element comprises a butterfly valve.

5. The heated valve according to claim 1, wherein the heating system comprises:
a heating element operably disposed within at least the valve body; and
a power source coupled to and configured to activate the heating element to generate heat.

6. The heated valve according to claim 5, wherein the valve element comprises a valve plate and a drive shaft configured to drive movements of the valve plate and the heating system comprises:
a valve plate heating element disposed to heat the valve plate; and
a coupling configured to electrically connect the valve plate heating element and the power source during movements of the valve element.

7. The heated valve according to claim 5, wherein the valve body comprises first and second layers and the heating element comprises a resistance wire interposed between the first and second layers.

8. The heated valve according to claim 7, wherein the valve body further comprises a seal ring disposable on an interior surface of an innermost one of the first and second layers.

9. A valve body, comprising:
an inner layer formed to define an inlet, an outlet downstream from the inlet and a valve section fluidly interposed between the inlet and the outlet;
an outer layer disposed to surround the inner layer; and
a heating element operably interposed between the inner and outer layers and configured to generate heat proximate to a valve element operably disposed within the valve section to assume and move between valve closing and valve opening positions.

10. The valve body according to claim 9, wherein at least one of the inner and outer layers is configured to prevent fluid outflow from the valve section.

11. The valve body according to claim 9, wherein at least the valve section is annular and the valve element is a butterfly valve.

12. The valve body according to claim 9, wherein the heating element comprises a resistance wire interposed between the first and second layers.

13. The valve body according to claim 9, further comprising a seal ring disposable on an interior surface of an innermost one of the first and second layers.

14. An engine, comprising:
a gas turbine engine section;
a starter configured to start the gas turbine engine section; and
a valve system configured to control airflow into the starter during operations to start the gas turbine engine section, the valve system comprising:
a valve body;
a valve element operably disposed within the valve body to assume and move between valve body closing and valve body opening positions;
a heating element operably disposed within at least the valve body; and
a power source coupled to and configured to activate the heating element to generate heat.

15. The engine according to claim 14, further comprising a valve actuator configured to drive movements of the valve element.

16. The engine according to claim 14, wherein the valve body is disposable such that fluid pools on the valve element in the valve body closing position.

17. The engine according to claim 14, further comprising:
a valve element heater disposed to heat the valve element; and
a coupling configured to electrically connect the valve element heater and the power source during movements of the valve element.

18. The engine according to claim 14, wherein the valve body comprises first and second layers and the heating element comprises a resistance wire interposed between the first and second layers.

19. The engine according to claim 18, wherein the valve body further comprises a seal ring disposable on an interior surface of an innermost one of the first and second layers.

20. The engine according to claim 18, wherein the first and second layers and the resistance wire comprise metallic materials.
